(19) United States
(12) Patent Application Publication
(10) Pub. No.: US 2015/0093187 A1
(43) Pub. Date: Apr. 2, 2015

(54) Method for producing a non-detachable connection between at least two workpieces, and connection produced according to this method

(71) Applicant: KACO GmbH + Co., KG, Heilbronn (DE)

(72) Inventor: Mario Voll, Kirchardt (DE)

(21) Appl. No.: 14/497,362

(22) Filed: Sep. 26, 2014

(30) Foreign Application Priority Data
Sep. 27, 2013 (DE) 10 2013 016 562.8

(51) Int. Cl. B23K 20/12

(52) U.S. Cl. CPC B23K 20/12
USPC 403/270; 29/505; 29/432.1

(57) ABSTRACT

In a method for producing a non-detachable connection between a first workpiece and a second workpiece, a material of a workpiece region of the first workpiece is locally heated by friction heat by rotating a tool contacting the workpiece region. The material of the workpiece region is shaped to form a bush that projects beyond the first workpiece. The bush is integrally and monolithically connected to a material of the second workpiece by the friction heat contained in the material of the bush. Preferably, the first workpiece is a sheet metal and the second workpiece is a sleeve.

### BACKGROUND OF THE INVENTION

The invention relates to a method for producing a non-detachable connection between at least two workpieces. The invention further relates to a connection produced according to this method.

In the automotive industry it is common to use screw connections in which weld-on nuts are welded onto a sheet-metal workpiece. These weld-on nuts comprise a thread on their inner wall. A hole is made in the sheet metal, with the diameter of the hole approximately corresponding to the internal diameter of the sleeve. Subsequently, the sleeve comprising the thread is welded onto the sheet metal, in particular by using resistance welding, so that subsequently, through the opening in the sheet metal, a screw can be screwed into the sleeve. Producing such a connection is elaborate and cost-intensive. The sheet metal parts first need to be drilled or perforated. The internal thread is made in the sleeves by using material-removing machining, and subsequently the sleeve is welded in exactly the right position in the region of the pre-drilled or perforated hole. Material-removing machining to produce the threads results in an expensive process and in very substantial material consumption.

It is the object of the invention to design the method of the aforementioned kind and the connection of the aforementioned kind in such a manner that an economical process is possible which nevertheless meets the requirements in terms of the connection.

### SUMMARY OF THE INVENTION

According to the invention, this object is solved in regard to the method of the aforementioned kind in that a first workpiece is locally heated, by rotating a tool, in such a manner that the heated workpiece region can be shaped to form a bush that projects beyond the workpiece, and in that the friction heat is such that the displaced material in the form of the bush integrally connects with the material of the second workpiece.

In regard to the connection of the aforementioned kind, this object is solved in accordance with the invention in that a first workpiece comprises a formed bush that is integrally and monolithically connected with the second workpiece in such a manner that the connection is seamless, i.e., there is no seam.

Accordingly, a first workpiece is first locally heated, by using a rotating tool, in such a manner that the heated workpiece region becomes soft and, by means of the tool, can be shaped to form a bush that projects beyond the first workpiece. The friction heat is such that the displaced material in the form of the bush integrally and monolithically connects with the material of the second workpiece. The integral connection between the two workpieces results in an impeccable rigid (fast or fixed) connection between the two workpieces.

In a preferred embodiment, the first workpiece is sheet metal-shaped while the second workpiece is sleeve-shaped. In principle, it is also possible that it is not the entire workpiece but only a workpiece region that is shaped like sheet metal. The thin workpiece region can easily be heated by using the tool so that the bush can be formed from the heated workpiece region.

The sleeve-shaped workpiece, which can be an individual sleeve or a sleeve-shaped region of a larger, further, workpiece, is seated on the shaped bush and is rigidly (fixedly) connected with said bush.

Advantageously, an internal thread is produced in the inner wall of the sleeve-shaped workpiece and in the inner wall of the shaped bush. Consequently, part of the thread is also formed by the shaped bush. In this manner an adequate thread length is obtained.

The terms “thin workpiece region” or “sheet-metal-shaped” denote that with the application of heat, in particular of friction heat, the workpiece region can be heated to such an extent that this workpiece region can be deformed.

Advantageously, the sleeve-shaped workpiece is positioned on the first workpiece, and only then the first workpiece is heated in the region of the sleeve-shaped workpiece. The soft material resulting from this is then displaced into the sleeve-shaped workpiece. The heated displaced workpiece region integrally and monolithically connects with the sleeve-shaped workpiece. Such an approach results in impeccable gas-tightness of the connection in the non-screwed-in and in the screwed-in states. Because of the integral connection between the displaced workpiece region and the sleeve-shaped workpiece, no seam or the like is formed by way of which gas could pass. Because of the integral connection, the thread situated in the sleeve-shaped workpiece can reliably withstand very considerable tightening torque, which can be, for example, between 9 and 12 Nm.

The internal contour of the sleeve also significantly determines the flow of the displaced material.

In order to locally heat the workpiece, advantageously a flow drilling device is used. By means of it, during the flow drilling process, the material of the workpiece is heated by friction heat to such an extent that this heated material can be displaced by the flow drilling device in order to form the bush. Consequently, it is possible in one work step to make the opening in the workpiece, to deform the heated edge region of the opening to the bush, and to connect the sleeve-shaped workpiece rigidly, in particular integrally and monolithically, with the formed bush of the workpiece.

The heated workpiece region is displaced by the flow drilling device into the accommodation space of the sleeve-shaped workpiece. Said workpiece region is advantageously formed by an enlargement of the diameter, which enlargement has been provided on the inside and has been selected so that the displaced material can be accommodated.

Advantageously, the sleeve-shaped workpiece is shaped in such a manner that its wall thickness is constant along its axial length. In the region in which the sleeve-shaped workpiece adjoins the first workpiece, the sleeve-shaped workpiece has been widened, and consequently the accommodation space is formed. The sleeve-shaped workpiece can be drawn to greater dimensions or can comprise a greater diameter in this region.

Advantageously, the accommodation space of the sleeve-shaped workpiece is of a size that the displaced material of the first workpiece completely fills the accommodation space. As a result of this, subsequently the wall thickness of the sleeve-shaped workpiece is greater in the region of the accommodation space than in the adjoining region. The sleeve-shaped workpiece adjoins with the reinforced wall section the first workpiece; consequently, reliable strength is provided in this transition region between the sleeve-shaped workpiece and the workpiece.

Ideally, the accommodation space and the displaced material are matched in such a manner that the displaced material completely fills the accommodation space. In any event, the size of the accommodation space is sufficient to ensure that no displaced material remains outside the accommodation space, which material could otherwise destroy the connection.

Advantageously, the accommodation space is filled with the displaced material in such a manner that the internal diameter of the filled accommodation space equals the internal diameter of the adjoining region of the sleeve-shaped workpiece. As a result of this, the sleeve-shaped workpiece has a constant internal diameter along its length. Since the heated region of the first workpiece has been displaced into the accommodation space of the sleeve-shaped workpiece, this displaced material is integrally and monolithically formed with the sleeve-shaped workpiece.

Consequently, the thread can extend from the side of the first workpiece, which side faces away from the sleeve-shaped workpiece, towards the interior into the sleeve-shaped workpiece. Thus this workpiece can also be used to form the internal thread. This enables long thread lengths that contribute to a very high load capacity.

Furthermore, the sleeve-shaped workpiece is connected with the first workpiece in such a manner that an integral connection between the two components is produced. This integral connection arises not only in the region of the material displaced into the accommodation space, but also in the contact region of the sleeve-shaped workpiece on the second workpiece. As a result of heating, in particular as a result of the high friction heat, an integral connection between the sleeve-shaped workpiece and the workpiece in the contact region of the sleeve-shaped workpiece is produced. Thus, a connection is provided that constitutes a single-piece design between the sleeve-shaped workpiece and the first workpiece. Consequently, an absolutely gas-proof design of the connection is advantageously ensured.

The connection according to the invention is characterised in that the first workpiece has a formed bush that is integrally and monolithically connected with the second workpiece in such a manner that the connection is seamless.

Advantageously, at its end facing the first workpiece, the sleeve-shaped workpiece comprises the accommodation space that accommodates the material displaced from the first workpiece.

This displaced material is integrally and monolithically connected with the material of the sleeve-shaped workpiece.

The sleeve-shaped workpiece of the connection advantageously comprises a constant internal diameter along its length. Therefore the thread can be provided over a long length.

To ensure a secure connection between the two workpieces, the sleeve-shaped workpiece advantageously comprises a radial flange with which it rests against the first workpiece. Therefore the sleeve-shaped workpiece and the first workpiece can be impeccably positioned relative to each other so that the two parts can reliably be interconnected.

Advantageously, the radial flange of the sleeve-shaped workpiece is integrally and monolithically formed with the first workpiece. The integral connection results in that when the connection is established the first workpiece is heated up to such an extent in the support region of the sleeve-shaped workpiece that the materials of the radial flange of the sleeve-shaped workpiece and of the first workpiece integrally and monolithically connect.

When the two parts of the connection are rigidly (fixedly) interconnected, the thread can be formed subsequently without any problems.

The subject matter of the application not only results from the subject matter of the individual claims, but also from all the information and characteristics disclosed in the drawings and in the description. Even if they are not part of the subject matter of the claims, they are claimed to be significant in the context of the invention to the extent that, individually or in combination, they are novel when compared to prior art.

Further characteristics of the invention are disclosed in the further claims, in the description, and in the drawing.

### BRIEF DESCRIPTION OF THE DRAWINGS

The invention will be explained in more detail with reference to an exemplary embodiment shown in the drawing. The following is shown:

FIG. 1 the method-related procedure in the production of a connection according to the invention between two components (workpieces);

FIG. 2 an enlarged view of an axial section of a sleeve that forms part of the connection according to the invention.

### PREFERRED EMBODIMENTS

In the following, the connection according to the invention is explained as an example with reference to a screw connection in which a sleeve is non-detachably connected with a piece of sheet metal.

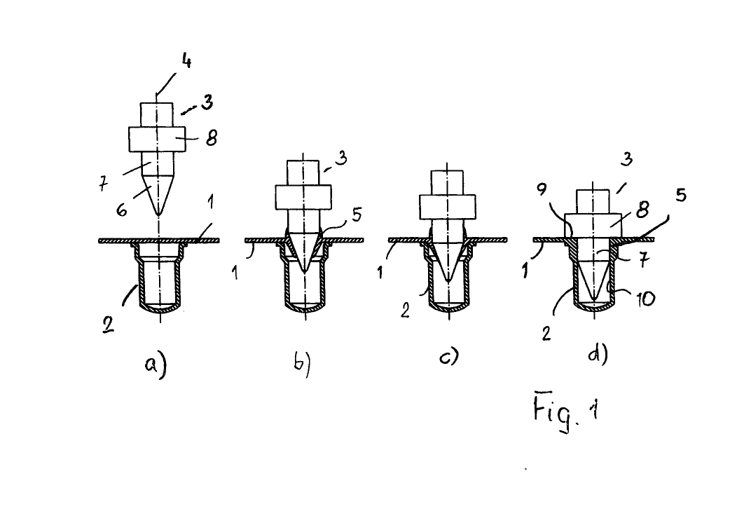

FIG. 1a shows the initial position. A piece of sheet metal 1, which advantageously comprises a metallic material, is to be non-detachably connected with a sleeve 2. To this effect the sheet metal 1 (first workpiece in this embodiment) and the sleeve 2 (second workpiece in this embodiment) are firmly pressed against each other by means of a clamping device (not shown). Subsequently, a flow drilling device 3 on the side facing away from the sleeve 2 is moved towards the sheet metal 1. The flow drilling device is rotatably driven on its axis 4. Such flow drilling devices are known and are therefore only briefly explained below. The flow drilling device 3 is pressed at high rotational speed and with substantial axial force against the thin-walled sheet metal 1. Depending on the thickness of the sheet metal 1 the rotational speed of the flow drilling device 3 can range from approximately 1,000 rpm to 5,500 rpm. The feed rate can, for example, exceed 100 mm/min, e.g. approximately 150 mm/min. The axial feed of the flow drilling device 3 can be done manually. Advantageously, however, there is an automatic feed that can be constant, variable or stepped. The flow drilling device 3 can, for example, be used in a box column drill, in an NC machine, in a CNC machine or in specially designed equipment. The rotational speed of the flow drilling device 3 depends on the diameter of the hole to be drilled in the sheet metal 1. The smaller the diameter of the hole, the higher the rotational speed.

The sheet metal 1 can comprise a thickness that preferably ranges from approximately 0.5 mm to approximately 5 mm. A sheet metal thickness of between approximately 0.75 mm and approximately 1.5 mm is particularly advantageous.

The rotating flow drilling device 3 is placed at a corresponding pressure onto the sheet metal 1. As a result of friction heat, the sheet metal material becomes soft or deformable. As shown in FIG. 1b, the deformed material 5 of the sheet metal 1 is displaced in the direction of feed and partly also against the direction of feed of the flow drilling device 3. The aforesaid comprises a conical work element 6, that tapers off in the direction of feed and during feed of the flow drilling device 3 displaces the deformed material 5 towards the outside. The conical work element 6 passes into a cylindrical work element 7 by means of which the deformed material 5, which in the direction of feed is displaced forward, is displaced radially outward at the end of the flow drilling process (FIG. 1d) in such a manner that its connects with the sleeve 2 in a manner that is yet to be described.

The cylindrical work element 7 adjoins a cylindrical stamp part 8 whose diameter is greater than the diameter of the work element 7. By means of said stamp part 8, the material displaced against the direction of feed of the flow drilling device 3 is displaced forwardly in the direction of feed into the sleeve 2 at the end of the flow drilling process. The flow drilling device 3 is moved in the direction of feed until the stamp part 8 with its planar ring surface 9 rests against the sheet metal 1. The stamp part 8 ensures that no material projects beyond the rear of the sheet metal 1, which rear faces away from the sleeve 2. The stamp part 8 together with the cylindrical work element 7 ensures that the deformed sheet metal material is completely displaced into the sleeve 2.

The stamp part 8 can also comprise at least one cutter by means of which any material projecting beyond the rear of the sheet metal 1 is then machined.

The sheet metal material 5 displaced by the flow drilling device 3 integrally and monolithically connects with the sleeve 2 so that said sleeve 2 comprises a constant internal diameter over its axial length (FIG. 1d). The diameter of the cylindrical work element 7 matches the internal diameter of the sleeve 2 so that the external diameter of the work element 7 corresponds to the internal diameter of the sleeve 2.

Because of the very considerable friction heat arising during flow drilling, the sheet metal 1 and its displaced material 5 integrally and monolithically connect with the material of the sleeve 2 so that a faultless non-detachable connection between the sheet metal 1 and the sleeve 2 is produced. On completion of flow drilling the flow drilling device 3 is withdrawn from the sleeve 2, which is now attached to the sheet metal 1.

Only after the connection between the sleeve 2 and the sheet metal 1 has been established, a thread is produced in the inner wall of the sleeve 2. Said thread can be produced in the inner wall 10 of the sleeve 2 by means of a thread cutting procedure, advantageously, however, by a thread-forming process. The thread-forming process is advantageous in that material hardening in the region of the thread is achieved and the load capacity of the thread is improved. No material is removed during thread forming, which would result in weakening of the connection.

In the exemplary embodiment the conical work element 6 of the flow drilling device 3 is moved against the closed sheet metal 1, wherein, in the manner described, as a result of friction heat the sheet metal material in the region of the work element 6 becomes soft and during the further feed of the flow drilling device 3 is displaced. In principle, it is also possible to produce pilot holes in the sheet metal 1, wherein subsequently the flow-drilled holes are produced in said pilot holes. Making pilot holes is associated with an advantage in that the flow drilling device 3 can be moved with less axial force against the sheet metal 1.

With the flow drilling device 3 it is possible to process workpieces of steel, aluminium, brass, copper and the like. Since in flow drilling only the material of the sheet metal 1 is displaced there is no waste in the flow drilling process, which waste would otherwise have to be disposed of laboriously. The described connection between the sheet metal 1 and the sleeve 2 can be produced in the shortest possible time by means of the flow drilling process. Producing a connection requires, for example, only 2 to 10 seconds.

In the above-mentioned alternative of machining by cutting the projecting material, chips are produced; however, they are produced only in such small quantities that they do not impede the production process. Moreover, they are easily removed.

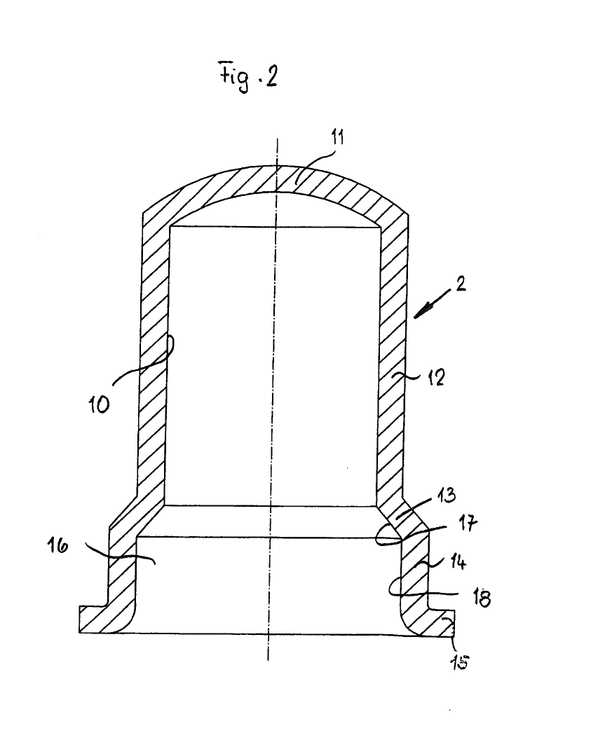

The sleeve 2, in whose inner wall 10 the thread is to be produced, is hat-shaped (FIG. 2) and comprises an outwardly curved bottom 11. The latter is provided on one end of a cylindrical jacket 12 of the sleeve 2. The jacket 12 passes, via a conical intermediate section 13, into a cylindrical end section 14 that, at its free end, comprises an outwardly projecting radial flange 15. The internal diameter and the external diameter of the end section 14 exceed those of the jacket 12. During the flow drilling process, the radial flange 15 of the sleeve 2 rests against the sheet metal 1 so as to be fully in contact with it (FIGS. 1a to 1c).

As a result of the conical intermediate section 13, the sleeve 2 comprises an accommodation space 16 at its end facing away from the bottom 11; this accommodation space 16 is delimited by the inner wall 17 of the conical intermediate section 13 and by the inner wall 18 of the end section 14. The inner wall 17 adjoins the inner wall 10 of the jacket 12 at an obtuse angle.

The annular accommodation space 16 is dimensioned so that it can accommodate the deformed material 5 arising during the flow drilling process, which material 5 is displaced into the accommodation space 16 by the two work elements 6, 7 of the flow drilling device 3 in such a manner that the sheet metal material 5 completely fills the accommodation space 16 (FIG. 1d). The materials of the sheet metal 1 and of the sleeve 2 are matched in such a manner that the described integral connection between the sheet metal 1 and the sleeve 2 is ensured. Because of the very considerable friction heat arising during flow drilling, the material of the radial flange 15 of the sleeve 2 also integrally and monolithically connects with the sheet metal 1 (FIG. 1d).

After the flow drilling process the sleeve 2 has a constant internal diameter along its entire length so that the thread can be produced without any problems in the inner wall of the sleeve 2. The integral connection of the sleeve 2 with the sheet metal 1 provides an impeccable rigid (fast or fixed) connection between the two components. Because the accommodation space 16 of the sleeve 2 has been filled by the displaced sheet metal material 5, the connection region of the sleeve 2 to the sheet metal 1 is reinforced, which contributes to good torsion resistance.

When the thread is made, the thread is cut into the displaced material 5 of the sheet metal 1, which material 5 is situated in the accommodation space 16 of the sleeve 2, and into the inner wall 10 of the jacket 12. Consequently, the thread extends from the outside of the sheet metal 1, which outside faces away from the sleeve 2, into the sleeve 2 so that a long thread length is achieved.

In order to connect the sleeve 2 with the sheet metal 1, it is also possible initially to process only the sheet metal 1 in the described manner by means of the flow drilling device 3. At the end of the flow process the displaced sheet metal material 5 forms a bush that projects beyond the sheet metal 1, the internal diameter of said bush being determined by the external diameter of the cylindrical work element 7 of the flow drilling device 3. Subsequently, the sleeve 2 is placed onto the thus-formed bush of the sheet metal 1 and is connected with the bush by means of a welding process, for example by resistance welding. Thereafter, the thread is produced.

In both methods, it is possible to make the screw connection so that it is gas-proof, and consequently the nuts in the form of the sleeves 2 can be used without any problems where gas-proof screw connections are required. Such screw connections are, for example, used in the automotive industry.

The described method can, for example, also be used with components made from thermoplastics. Here again, as a result of the flow drilling process, the material can be softened because of the friction heat and then can be deformed or displaced by the flow drilling device, as has been described with reference to FIG. 1.

The described method is not limited to connecting a piece of sheet metal with a sleeve. In the same manner it is, for example, also possible to interconnect two pieces of sheet metal. They are placed one on top of the other and by means of a suitable clamping device are firmly pressed against each other. Subsequently, a hole flow-drilling process as described above is carried out by means of the flow drilling device 3. At the required positions, the hole flow-drilling device 3 is pressed through the two pieces of sheet metal that have been clamped together. The sheet metal material is heated to such an extent that a rigid (fast or fixed) non-detachable connection between the two pieces of sheet metal placed one on top of the other results.

The instant specification incorporates by reference the entire disclosure of German priority application 10 2013 016 562.8 having a filing date of Sep. 27, 2013.

While specific embodiments of the invention have been shown and described in detail to illustrate the inventive principles, it will be understood that the invention may be embodied otherwise without departing from such principles.

What is claimed is:

1. A method for producing a non-detachable connection between a first workpiece and a second workpiece, the method comprising:
locally heating by friction heat a material of a workpiece region of a first workpiece by rotating a tool that is contacting the workpiece region;
shaping the material of the workpiece region to form a bush that projects beyond the first workpiece;
integrally and monolithically connecting the bush to a material of the second workpiece by the friction heat contained in the material of the bush.

2. The method according to claim 1, further comprising configuring the first workpiece as a sheet metal and the second workpiece as a sleeve.

3. The method according to claim 2, further comprising placing the sleeve on the bush and fixedly connecting the sleeve and the bush.

4. The method according to claim 2, further comprising producing an internal thread in the bush and in the sleeve after the step of integrally and monolithically connecting.

5. The method according to claim 2, further comprising placing the sleeve onto the workpiece region of the first workpiece prior to the step of locally heating and displacing the material of the workpiece region heated by the friction heat into the sleeve during the step of shaping.

6. The method according to claim 5, further comprising, in the step of displacing, filling an accommodation space of the sleeve.

7. The method according to claim 6, filling the accommodation space of the sleeve completely at least to a large extent.

8. The method according to claim 2, wherein the sleeve and the bush are integrally and monolithically connected.

9. The method according to claim 1, further comprising selecting a flow drilling device as the tool.

10. A connection produced according to claim 1, wherein the bush of the first workpiece is shaped such that the second workpiece and the bush are connected to each other integrally and monolithically without a seam.

11. The connection according to claim 10, wherein the second workpiece is a sleeve and comprises an end that is facing the first workpiece, wherein the end comprises an accommodation space that receives the material of the workpiece region that is being displaced during shaping.

12. The connection according to claim 11, wherein the sleeve comprises a constant internal diameter across a length of the sleeve.

13. The connection according to claim 11, wherein the sleeve comprises a radial flange connected to the end, wherein the radial flange of the sleeve is resting against the first workpiece.

14. The connection according to claim 13, wherein the radial flange is integrally and monolithically connected to the first workpiece.
